(19) United States
(12) Patent Application Publication
(10) Pub. No.: US 2013/0303132 A1
(43) Pub. Date: Nov. 14, 2013

(54) METHODS AND SYSTEMS FOR CREATING CUSTOMIZED RINGTONES BASED ON CALLER INFORMATION

(71) Applicant: Yat Wai Edwin Kwong, Causeway Bay (HK)

(72) Inventor: Yat Wai Edwin Kwong, Causeway Bay (HK)

(21) Appl. No.: 13/467,043

(22) Filed: May 9, 2012

(51) Int. Cl. H04W 4/00

(52) U.S. Cl. 455/414.1

(57) ABSTRACT

According to embodiments of the invention, systems and methods are provided for generating a customized ringtone based on available data regarding a caller. Generally, the systems and methods employ a mobile device with a phonebook and ringtone music merger component installed thereon or remotely accessible via a wireless network. When an incoming call is received, data regarding the caller is determined based on the caller's phone number as well as any contact information of the caller that may be in the phonebook. The data may include the name, city, local time, and country of the caller. All of the gathered data is then compiled into a custom audio ringtone that is played on the mobile phone. The ringtone may also include an audio version of the national anthem of the country from which the caller is calling, as well as the international calling rates from that country.

### FIELD OF THE INVENTION

This invention is generally related to mobile phone technology. More specifically, this invention is related to a system and method for electronically creating ringtones specific to certain callers.

### BACKGROUND OF THE INVENTION

On mobile devices, a ringtone can be a short audio file played to indicate an incoming call. A popular ringtone might consist of several bars of a familiar musical sound. Such ringtones are popular because, in a crowd of people with many cellular device sets, they make it easy to tell whose phone receiving an incoming call. Moreover, they serve to personalize a mobile phone to a persons liking. The popularity of cellular telephones, for example, in recent years has given rise to a wide variety of ringtones.

The earliest form of a ringtone was the tone a caller hears indicating that the phone at the recipient's end was ringing. On a traditional calling device, the tone is sent back in between the ring sequence at the receiving end. The pulsing rate is one on, two off, and so on from a 3-phase generator with each call using a single phase. The called and calling phones would not necessarily use the same phase, so if a caller wanted to ring someone's phone, they would need to hear it ringing for a full cycle to make sure that the phone actually rang at the other end.

Ringtone service is changing. Ring Tones provide new personalization services, replacing the standard ringtone for friends and family to enjoy. One may choose a song for the callers to hear before the other pick up a call. Also, the user may use the sound of popular music to express himself or herself before answering a call. Currently, however, there is no ringtone service that can dynamically create a ringtone based on both the receiver's and caller's information. In view of the foregoing, there is a need to provide such services.

### SUMMARY OF THE INVENTION

According to embodiments of the invention, methods and systems are provided for creating ringtones of mobile devices in light of music, calling countries, calling cities, callers' names, and local times of callers. In one embodiment, a system is provided, the including a mobile device belong to a receiver; a GPS receiver included in the mobile device; a ringtone music merger component, wherein the ringtone music merger component is used to combine the ringtones in light of music of caller's country, calling countries, calling cities, callers' names, and local times of callers; an address book included in the mobile device, wherein the address book contains a match of names of contacts and phone number of associated contacts; a database containing music of national anthems of different countries; and a time keeper, wherein the time keeper is used to convert time of caller to receiver's time in light of time zone of caller, wherein the receiver's time can be located by using the GPS receiver.

In an embodiment of the disclosed invention, a system for dynamically creating ringtones in light of several factors is provided. The systems components include a mobile device with GPS receiver and address book, a ringtone music merger component, a national anthem database, a time keeper, a processor and memory. The address book contains names and numbers of contacts. The ringtone music merger component may be a software program installed upon the mobile device that creates ringtones based on the caller and receiver's countries, cities, local times, and contact information. The time keep serves to convert the local time at the caller to that of the receiver, and vice-versa.

The memory contains instructions that cause the processor to execute a method. The method comprises the following steps. The first step being receiving an international call from the caller. The second step is enabling a ringtone feature. The ringtone feature comprises using the ringtone music merger component to create a ringtone only when the call is received. The step of creating involves determining several facts about the caller: 1) determining the country of the caller country based on the phone number of the caller; 2) determining the caller's city based on caller's area code; 3) determining the music of caller's country based on the caller's country and the associated national anthem stored in the database; 4) determining the caller's name based on the names and the associated phone numbers in the address book; and 5) determining a local time of caller by using the time keeper to convert local time of caller to the local time of receiver in light of time zone of caller by referring to the area code of caller. With all of the aforesaid information, the method proceeds by building a ringtone incorporating the determined national anthem of the caller's country, the name of the calling country, the name of the caller's city, the callers' name, and local time of the caller. Finally, the ringtone is played on the mobile device of receiver.

In further embodiments of the disclosed system, the ringtone music merger component may also determine how much the international call from the caller will cost if answered by the receiver. Then, the ringtone may further incorporate the international call cost into the ringtone.

In another embodiment of the disclosed technology, a method for automatically creating customized ringtones based on data available regarding a caller is provided. The first step involves providing a receiver with a mobile phone that has an electronic phonebook. The phonebook has a plurality of names and phone numbers associated with each of the plurality of names. The second step entails installing a ringtone music merger component on the mobile phone. The ringtone music merger component is operable to access available data regarding a caller. The method proceeds when a call is received on the mobile phone from the caller. At this time, the ringtone music merger component begins building a custom ringtone that incorporates available data regarding the caller. This data may include: 1) a city of the caller, as determined by the area code of the caller's phone number; 2) the name associated with the caller if the phone number of the caller is in the electronic phonebook; and 3) a local time at a location of the caller, the local time determined using the area code and a current time at the location of the mobile phone. The ringtone is then played on the mobile device to alert to the receiver to an incoming call. The ringtone comprises an audio dictation of the available data regarding the caller.

If the incoming call is an international call (i.e. a call from another country besides that of the mobile phone's service provider), then the data may also include the country of the caller as well as the national anthem of the caller's country. The national anthem being in the form of an audio file, such as a wave, MP3, flac, or any other audio file extension capable of being played on an electronic device. In this scenario, the national anthem and/or the name of the country is also incorporated into the ringtone that is played.

In a further embodiment of this method, the data may also have information regarding the international calling rate charged for calls from the caller's country. This rate would be provided by the receiver's mobile network provider, and would be audibly dictated in a form such as the specific dollar amount charged per minute for calls from that particular country. This audio dictation also being incorporated into the ringtone.

In accordance with these and other objects which will become apparent hereinafter, the invention will now be described with particular reference to the drawing.

### BRIEF DESCRIPTION OF THE DRAWINGS

FIG. 1 shows a flow chart of a method of carrying out embodiments of the disclosed invention.

### DETAILED DESCRIPTION

According to embodiments of the invention, systems and methods are provided for generating a customized ringtone based on available data regarding a caller. Generally, the systems and methods employ a mobile device or phone with a phonebook and ringtone music merger component installed thereon or remotely accessible via a wireless network. When an incoming call is received, data regarding the caller is determined based on the caller's phone number as well as any contact information of the caller that may be in the phonebook. The data may include the name, city, local time, and country of the caller. The data may also include the national anthem of the caller's country as well as the international calling rates for calls from the caller's country. All of the gathered data is then compiled into a custom audio ringtone that is played on the mobile phone. The ringtone may include an audio dictation of the caller's name, city, country, and local time, as well as the international calling rate associated with the incoming call. The ringtone may also include an audio version of the national anthem of the country from the caller is calling.

In an embodiment of the disclosed invention, a system for dynamically creating ringtones in light of several factors is provided. The systems components include a mobile device with GPS receiver and address book, a ringtone music merger component, a national anthem database, a time keeper, a processor and memory. The address book contains names and numbers of contacts. The ringtone music merger component may be a software program installed upon the mobile device that creates ringtones based on the caller and receiver's countries, cities, local times, and contact information. Alternatively, the ringtone music merger component may be accessible via a wireless network. The time keep serves to convert the local time at the caller to that of the receiver, and vice-versa.

The memory contains instructions that cause the processor to execute a method. The method comprises the following steps. The first step being receiving an international call from the caller. The second step is enabling a ringtone feature. The ringtone feature comprises using the ringtone music merger component to create a ringtone only when the call is received. The step of creating involves determining several facts about the caller: 1) determining the country of the caller country based on the phone number of the caller; 2) determining the caller's city based on caller's area code; 3) determining the music of caller's country based on the caller's country and the associated national anthem stored in the database; 4) determining the caller's name based on the names and the associated phone numbers in the address book; and 5) determining a local time of caller by using the time keeper to convert local time of caller to the local time of receiver in light of time zone of caller by referring to the area code of caller. With all of the aforesaid information, the method proceeds by building a ringtone incorporating the determined national anthem of the caller's country, the name of the calling country, the name of the caller's city, the callers' name, and local time of the caller. Finally, the ringtone is played on the mobile device of receiver.

In further embodiments of the disclosed system, the ringtone music merger component may also determine how much the international call from the caller will cost if answered by the receiver. Then, the ringtone may further incorporate the international call cost in the ringtone.

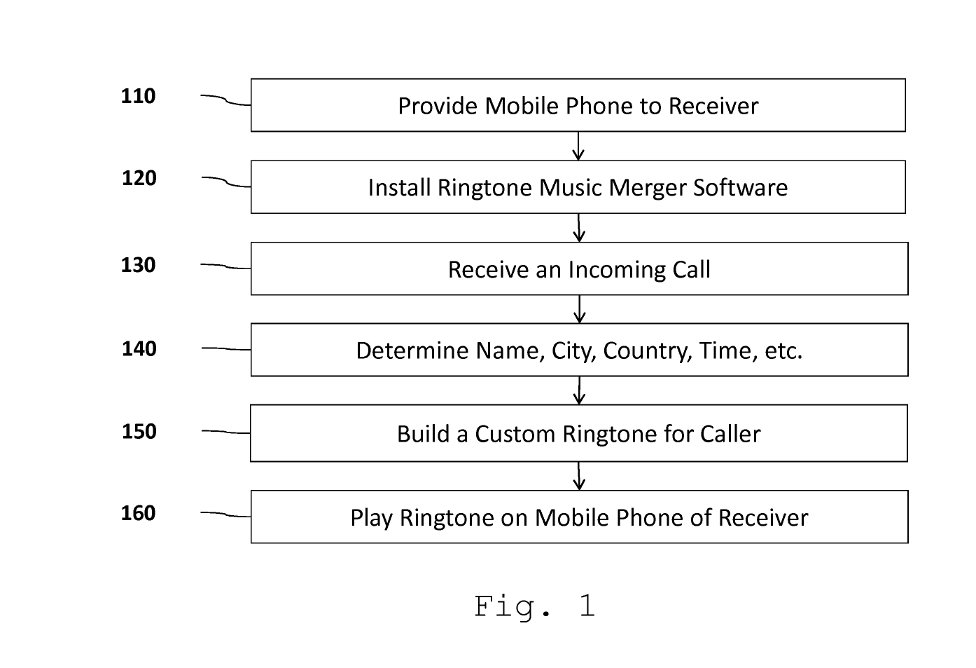

Referring now to the drawings, FIG. 1 shows a flow chart of a method of carrying out embodiments of the disclosed technology. In the particular embodiment shown, a method for automatically creating customized ringtones based on data available regarding a caller is provided. The first step 110 involves providing a receiver with a mobile phone that has an electronic phonebook. The phonebook has a plurality of names and phone numbers associated with each of the plurality of names. The second step 120 entails installing a ringtone music merger component on the mobile phone. The ringtone music merger component is operable to access available data regarding a caller. The method proceeds when a call is received 130 on the mobile phone from the caller. Data is then gathered and determined 140 regarding the caller. This data may include: 1) a city of the caller, as determined by the area code of the caller's phone number; 2) the name associated with the caller if the phone number of the caller is in the electronic phonebook; and 3) a local time at a location of the caller, the local time determined using the area code and a current time at the location of the mobile phone. At this time, the ringtone music merger component begins building a custom ringtone 150 that incorporates available data regarding the caller. The ringtone is then played on the mobile device 160 to alert to the receiver to an incoming call. The ringtone comprises an audio dictation of the available data regarding the caller.

If the incoming call is an international call (i.e. a call from another country besides that of the mobile phone's service provider), then the data may also include the country of the caller as well as the national anthem of the caller's country. The national anthem being in the form of an audio file, such as a wave, MP3, flac, or any other audio file extension capable of being played on an electronic device. In this scenario, the national anthem and/or the name of the country is also incorporated into the ringtone that is played.

In a further embodiment of this method, the data may also have information regarding the international calling rate charged for calls from the caller's country. This rate would be provided by the receiver's mobile network provider, and would be audibly dictated in a form such as the specific dollar amount charged per minute for calls from that particular country. This audio dictation also being incorporated into the ringtone.

To summarize, the ringtone played when a specific caller is calling the mobile device will tell the receiver important information about the call and/or the caller. An example of a ringtone for an incoming call from France may be an audio transcript spoken with the French national anthem playing in the background. The audio transcript may read, for example, “Incoming call from Pierre in Paris, France where the local time is 10:30 AM. Accepting this call will result in an international calling rate of two dollar per minute being charged to your wireless phone account”.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

What is claimed is:

1. A system for dynamically creating ringtones in light of several factors, the system comprising:
a mobile device of a receiver comprising a GPS receiver and an address book, wherein the address book contains names and phone numbers of associated contacts;
a ringtone music merger component for creating ringtones comprised of music that is chosen based on one or more of the following factors:
a country of a caller;
a country of a receiver
a city of the receiver;
contact information of the caller from an address book of the receiver; and a local time of the caller;
a database comprising music of national anthems of different countries;
a time keeper for converting a local time of the caller to a local time of the receiver;
a processor; and
a memory containing instructions that can be executed by the processor, the instructions comprising:
receiving an international call from the caller;
enabling a ringtone feature, wherein the ringtone feature comprises:
using the ringtone music merger component to create a ringtone only when the call is received, wherein the creating comprises:
determining the country of the caller country based on a phone number of the caller;
determining the caller's city based on the caller's area code;
determining the music of caller's country based on the caller's country and the associated national anthem stored in the database;
determining the caller's name based on the names and the associated phone numbers in the address book;
determining a local time of caller by using the time keeper to convert local time of caller to the local time of receiver in light of time zone of caller by referring to the area code of caller; and
building a ringtone incorporating the determined national anthem of the caller's country, the name of the calling country, the name of the caller's city, the callers' name, and local time of the caller; and
playing the ringtone on the mobile device of receiver.

2. The system of claim 1, wherein:
the ringtone music merger component also determines how much the international call from the caller will cost if answered by the receiver; and
the ringtone further incorporates the international call cost in the ringtone.

3. A method for automatically creating customized ringtones based on data available regarding a caller, the method comprising the following steps:
providing a receiver with a mobile phone that comprises an electronic phonebook, the phonebook comprising a plurality of names and phone numbers associated with each of the plurality of names;
installing a ringtone music merger component on the mobile phone, the ringtone music merger component operable to access available data regarding a caller;
receiving, on the mobile phone, a call from the caller;
building a custom ringtone with the ringtone music merger component that incorporates available data regarding the caller, the data comprising:
a city of the caller, determined by an area code of a phone number of the caller;
a name associated with the caller if the phone number of the caller is in the electronic phonebook; and
a local time at a location of the caller, the local time determined using the area code and a current time at a location of the mobile phone; and
playing the ringtone on the mobile phone, the ringtone comprising an audio dictation of the available data regarding the caller.

4. The method of claim 3, wherein the call from the caller is an international call.

5. The method of claim 4, wherein the data further comprises a country of the caller and an audio file of a national anthem of the country of the caller; the country being determined based on a country calling code of a phone number of the caller.

6. The method of claim 5, wherein the ringtone further comprises:
an audio dictation of the country of the caller; and
the audio file of the national anthem of the country of the caller.

7. The method of claim 6, wherein the data further comprises an international calling rate of the call, the rate being determined based on international rates of a service provider of the mobile phone for calls from the country of the caller.

8. The method of claim 7, wherein the ringtone further comprises an audio dictation of the international calling rate of the call.

9. A method for automatically creating customized ringtones based on data available regarding a caller, the method comprising the following steps:
providing a receiver with a mobile phone that comprises an electronic phonebook, the phonebook comprising a plurality of names and phone numbers associate with each of the plurality of names;
installing a ringtone music merger component on the mobile phone, the ringtone music merger component operable to access available data regarding a caller;
receiving, on the mobile phone, a call from the caller;
building a custom ringtone that incorporates data available regarding the caller, the data comprising:
a country of the caller and an audio file of a national anthem of the country of the caller, if the call is determined to be an international call based on a country calling code of a phone number of the caller;
a city of the caller, determined by an area code of a phone number of the caller;
a name associated with the caller if the phone number of the caller is in the electronic phonebook; and
a local time at a location of the caller, the local time determined using the area code and a current time at a location of the mobile phone; and
playing the ringtone on the mobile phone, the ringtone comprising:
an audio dictation of the name, the country, the city, and the local time of the caller; and
the audio file of the national anthem of the country of the caller.

10. The method of claim 9, wherein the data further comprises an international calling rate of the call, the rate being determined based on international rates of a service provider of the mobile phone for calls from the country of the caller.

11. The method of claim 10, wherein the ringtone further comprises an audio dictation of the international calling rate of the call.
